(19) United States
(12) Patent Application Publication
(10) Pub. No.: US 2004/0095619 A1
(43) Pub. Date: May 20, 2004

(54) Image reader for use in image forming apparatus

(75) Inventor: Hideyuki Akaba, Kawasaki-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/294,613

(22) Filed: Nov. 15, 2002

(51) Int. Cl. H04N 1/23; H04N 1/29

(52) U.S. Cl. 358/509; 358/300

(57) ABSTRACT

An image reader of the present invention can be switched between a flatbed mode for obtaining a image light by directing an illuminating light with an object to be read kept still at a predetermined position of a transparent glass while moving an illuminating unit along the transparent glass when the object to be read includes a color image, and a sheet-through mode for obtaining an image light by directing an illuminating light to the object to be read being conveyed through a reading window when the object to be read includes only a monochrome image.

### BACKGROUND OF THE INVENTION

The present invention relates to an image reader for obtaining image data for an electrophotographic image forming apparatus, and an image forming apparatus having the image reader.

An image reader outputs image data by photo electric conversion of a reflected light obtained by illuminating an object to be read such as a sheet-like document, a book, a three dimensional object, or the like by an image reading sensor such as a CCD sensor.

As an image reading method used in an image reader, a flatbed method of placing an object to be read on a transparent document supporting portion (transparent glass), and moving an illuminating unit and an optical system such as a mirror or an image reading sensor along the transparent glass, is known widely.

Nowadays, a sheet-through method of fixing an optical system such as a mirror or an image reading sensor and an illuminating unit preliminarily at a predetermined position for defining the reading position, and conveying sheet-like objects to be read successively to the reading position is also widely used.

In both the flatbed and sheet-through methods, when the objects to be read are sheets of paper, etc., an automatic document feeding unit conveys the objects one by one toward the transparent glass, reads the image information, then discharges the object to a designated place while the next object is fed up to the transparent glass.

In many image readers, in order to achieve the above-mentioned two reading methods, a sheet-through reading position capable of the sheet-through method is provided together with the transparent glass. In many cases, the sheet-through reading position in the flatbed method is defined at a predetermined position further away from the tip end of the transparent glass as the accelerating section utilized for acceleration at the time of moving the illuminating unit and the optical system such as a mirror or the image reading sensor.

Next, the basic configuration of the flatbed method image reader capable of reading images by the sheet-through method will be explained.

In the flatbed method, a carriage supporting an illumination unit capable of illuminating the reading width as the total length in the transparent glass one side (width) direction, a mirror, or the like along the reading length as the total length of the other side (length) direction orthogonal to the reading width with a predetermined interval kept with respect to the transparent glass at a predetermined speed, and transmitting the reflected light from the object to be read (illuminated by the illuminating unit) to a CCD sensor fixed at a position not to disturb the carriage movement using a lens, or the like, is used.

In contrast, in obtaining image data from a sheet of paper, etc. using the sheet-through method, the carriage is fixed at a position facing the transparent glass, and reflects the light from the reading position to the CCD sensor, and the objects to be read are successively conveyed to the reading position.

In the sheet-through method, since the object to be read is moving, it is suitable for monochrome images (black) containing characters, graphics, etc., and for high-speed copying where the image-forming speed is high.

In contrast, when the object to be read is a color document such as a photograph, or when a high reading accuracy is required, it is desirable to use the flatbed method.

However, in the flatbed method, the time needed for conveying the object to be read to a predetermined position of the transparent glass and the time needed for moving the object to be read whose image information is read out, from the transparent glass are required. Moreover, the carriage supporting the illuminating unit for illuminating the reading width as the total length of one side (width) direction of the object to be read, the mirror, or the like needs to be moved at a predetermined speed along the reading length as the total length in the other side (length) direction orthogonal to the reading width. That is, according to the flatbed method, a problem is involved in that the time needed for reading the image information from the object to be read is longer than that of the sheet-through method.

Jpn. Pat. Appln. KOKAI Publication No. 2000-307821 discloses an image reader capable of reading a document by both the sheet-through scanning method and the flatbed scanning method.

According to the image reader disclosed in the publication, after reading all the documents by the sheet-through scanning method, in the case where it is recognized to be a color document using the image data, the image data is obtained again consecutively by the flatbed scanning method. According to the method, the image data of the color document is obtained by two kinds of the sheet-through scanning method and the flatbed scanning method. Of course, the step of obtaining the image data by the sheet-through scanning method and the image data read out by the sheet-through scanning method are wasted. Moreover, a problem is involved in that the time required for obtaining the image data of a color document by the flatbed scanning method is increased.

### BRIEF SUMMARY OF THE INVENTION

Accordingly, an object of the present invention is to provide an image reader capable of setting a reading method according to an image information state of an object to be read, and an automatic document feeding unit.

According to an aspect of the present invention, there is provided an image reader comprising:

a CCD sensor which converts a reflected light produced by illuminating an object to be read to an image signal;

a transparent glass which supports the object to be read in a stationary state, and directs the illuminating light to the object to be read from the side opposite to the side on which the object to be read is disposed;

a sheet conveying unit which conveys the object to be read toward the transparent glass when the object to be read is sheet-like, and has an image determining mechanism which determines whether the image of the object to be read is a color image or a monochrome image;

a reading window which is disposed between the sheet conveying unit and the transparent glass, and directs the illuminating light to a part of the object to be read being conveyed by the sheet conveying unit from the side opposite to the side to which the object to be read is moved;

an illuminating unit which moves along the transparent glass and stops at a predetermined position facing the reading window, and directs the illuminating light to the stationary object to be read on the transparent glass, and the object to be read being moved with the illuminating light directed from the reading window;

a mirror set which includes one or more mirrors, is capable of moving along the transparent glass, and transmits at least one of the reflected light produced by illuminating the object to be read by the illuminating light, and the reflected light produced by illuminating the object to be read by the illuminating light through the reading window, to the CCD sensor;

a carriage member which moves along the transparent glass at a predetermined speed while supporting the mirror set and the illuminating unit, and directs the reflected light produced by illuminating the object to be read by the illuminating light through the reading window to a position at which a predetermined mirror in the mirror set can receive the reflected light; and

an image information reading setting mechanism which, if the image determining mechanism detects that the object to be read holds a color image, even when a first reading mode for obtaining the reflected light by directing the illuminating light to the object to be read through the reading window while moving the object to be read is set, sets a second reading mode for obtaining the reflected light by directing the illuminating light to the object to be read while moving the carriage along the transparent glass after stopping the object to be read at a predetermined position of the transparent glass.

According to another aspect of the present invention, there is provided an image reader comprising:

a CCD sensor which converts a reflected light produced by illuminating an object to be read to an image signal;

a transparent glass which supports the object to be read in a stationary state, and is capable of directing the illuminating light to the object to be read from the side opposite to the side on which the object to be read is disposed;

a sheet conveying unit which is capable of conveying the object to be read toward the transparent glass when the object to be read is sheet-like;

a reading window which is disposed between the sheet conveying unit and the transparent glass, and is capable of directing the illuminating light to a predetermined area of the object to be read being conveyed by the sheet conveying unit from an opposite side direction to a direction to which the object to be read is moved;

an illuminating unit which moves along the transparent glass and is stopped at a predetermined position facing the reading window, and directs the illuminating light to the stationary object to be read on the transparent glass, and the object to be read being moved with the illuminating light directed from the reading window;

a mirror set which includes one or more mirrors, is capable of moving along the transparent glass, and transmits at least one of an image light produced by illuminating the object to be read by the illuminating light, and an image light produced by illuminating the object to be read by the illuminating light through the reading window, to the CCD sensor;

a carriage member which moves along the transparent glass at a predetermined speed while supporting the mirror set and the illuminating unit, and directs the image light produced by illuminating the object to be read by the illuminating light through the reading window to a position at which a predetermined mirror in the mirror set can receive the image light;

a type input mechanism which is capable of inputting whether the object to be read includes only a monochrome image or also a color image; and

an image information reading setting mechanism which, when the type input mechanism inputs that the object to be read includes only a monochrome image, focuses the image light to the CCD sensor with a first reading mode for obtaining the image light by directing the illuminating light to the object to be read through the reading window while moving the object to be read, and when the object to be read includes a color image, focuses the image light to the CCD sensor with a second reading mode for obtaining the image light by directing the illuminating light to the object to be read while moving the carriage along the transparent glass at a predetermined speed after stopping the object to be read at a predetermined position of the transparent glass.

According to still another aspect of the present invention, there is provided an image reader comprising:

a CCD sensor which converts a reflected light produced by illuminating an object to be read to an image signal;

a transparent glass which supports the object to be read in a state kept still, and is capable of directing the illuminating light to the object to be read from the side opposite to the side on which the object to be read is disposed;

a sheet conveying unit which is capable of conveying the object to be read toward the transparent glass when the object to be read is sheet-like;

a reading window which is disposed between the sheet conveying unit and the transparent glass, and is capable of directing the illuminating light to a part of the object to be read being conveyed by the sheet conveying unit from the side opposite to the side to which the object to be read is moved;

an illuminating unit which is capable of moving along the transparent glass and being kept still at a predetermined position facing the reading window, and is capable of directing the illuminating light to the object to be read being kept still on the transparent glass, and the object to be read being moved with the illuminating light directed from the reading window;

a mirror set which includes one or more mirrors, is capable of moving along the transparent glass, and transmits at least one of an image light produced by illuminating the object to be read by the illuminating light, and an image light produced by illuminating the object to be read by the illuminating light through the reading window, to the CCD sensor;

a carriage member which is capable of moving along the transparent glass at a predetermined speed while supporting the mirror set and the illuminating unit, and is capable of moving the image light produced by learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view showing an embodiment of an image forming apparatus having an image reader of the present invention assembled therein;

FIG. 2 is a schematic view for explaining an image reader usable integrally with the image forming apparatus shown in FIG. 1;

FIG. 3 is a schematic view for explaining an example of a sheet-through method operation of the image reader shown in FIG. 2;

FIG. 4 is a schematic view for explaining an example of a driving mechanism for moving first and second carriages in the image reader shown in FIGS. 2 and 3; and

FIG. 5 is a schematic block diagram for explaining an example of a control system of the image reader shown in FIGS. 2 to 4.

### DETAILED DESCRIPTION OF THE INVENTION

An embodiment of the present invention will now be described with reference to the drawings, an example of a digital copying machine as an image forming apparatus.

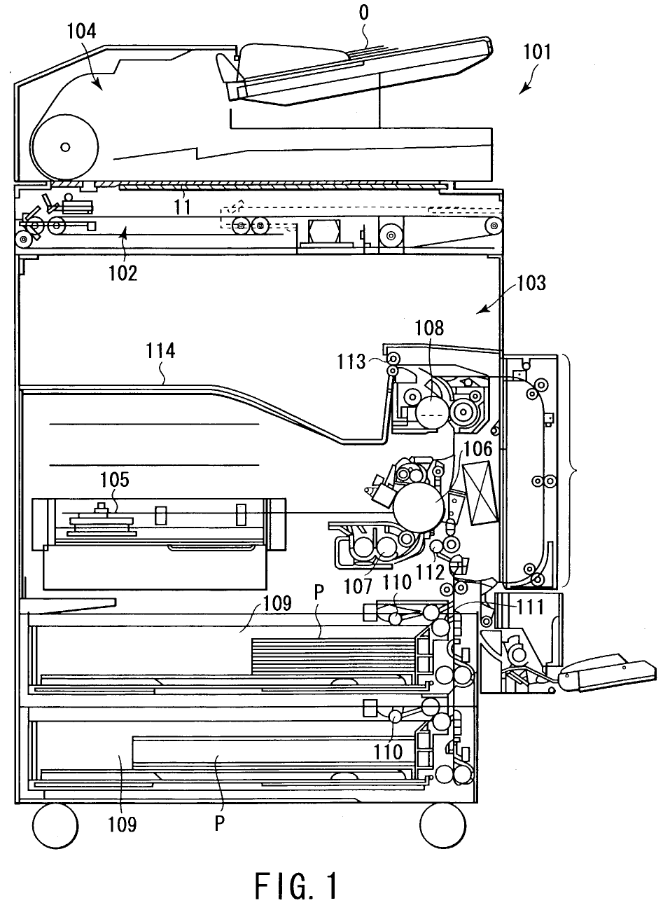

As shown in the schematic diagram of FIG. 1, the digital copying machine 101 includes an image reader 102 for obtaining image data by optically taking in an image of an object to be copied (object to be read) 0 as brightness or darkness of the light, and an image forming section 103 for forming an image corresponding to the image data supplied form the image reader 102 or the outside.

An automatic document feeding unit 104 for replacing the object to be read each time the image information reading operation from the object to be copied O by the image reader 102 is finished in the case where the object to be read (copied) O is sheet-like is provided integrally, in the image reader 102.

The image forming section 103 includes an exposing unit 105 for outputting a laser beam with the light intensity changed corresponding to the image data supplied from the image reader 102 or the external unit, a photosensitive drum 106 for exciting and supporting an image corresponding to the light intensity of the laser beam from the exposing unit 105, a developing unit 107 for supplying a developing agent (toner) to the image formed on the photosensitive drum 106 for development, a fixing unit 108 for heating and melting the toner image and a transfer material in a state with the developing agent image formed on the photosensitive drum 106, that is, the toner image formed on the photosensitive drum 106 by the developing unit 107 transferred on a material to be transferred, that is, a transfer material P by a sheet conveying portion for fixation on the transfer material P, or the like.

When image data is supplied from the image reader 102 or the external unit, a laser beam with the intensity modulated corresponding to the image data is irradiated from the exposing unit 105 on the surface of the photosensitive drum 106 preliminarily charged to a predetermined potential. Thereby, an electrostatic latent image corresponding to the image to be copied is formed on the photosensitive drum 106.

The electrostatic latent image formed on the photosensitive drum 106 is developed by selective supply of the toner by the developing unit 107 so as to be converted to a toner image (not shown). The toner image (not shown) formed on the surface of the photosensitive drum 106 is transferred onto the transfer material P at a transfer position where the transfer unit and the photosensitive drum 106 face each other (no numeral given).

The transfer materials P are supported in a cassette 109. The transfer materials P supported in the cassette 109 are taken out by a pickup roller 110 one by one from the cassette 109 so as to be conveyed in a conveyance path 111.

A sheet material conveyed in the conveyance path 111 is fed to the transfer position with the timing aligned with the toner image by an aligning roller 112 for matching the position of the sheet material with the position of the toner image formed on the photosensitive drum 106.

The toner image is fixed on the sheet material according to the movement in the conveyance path 111 of the sheet material in a state with the toner image transferred on the transfer material P adhered electrostatically on the sheet material so as to be conveyed to the fixing unit 108 and provided with heat and pressure from the fixing unit 108.

The sheet material having the toner image fixed thereon is discharged to a discharge space (sheet discharging tray) 114 defined between the image reader 102 and the cassette 109 via a discharge roller 113.

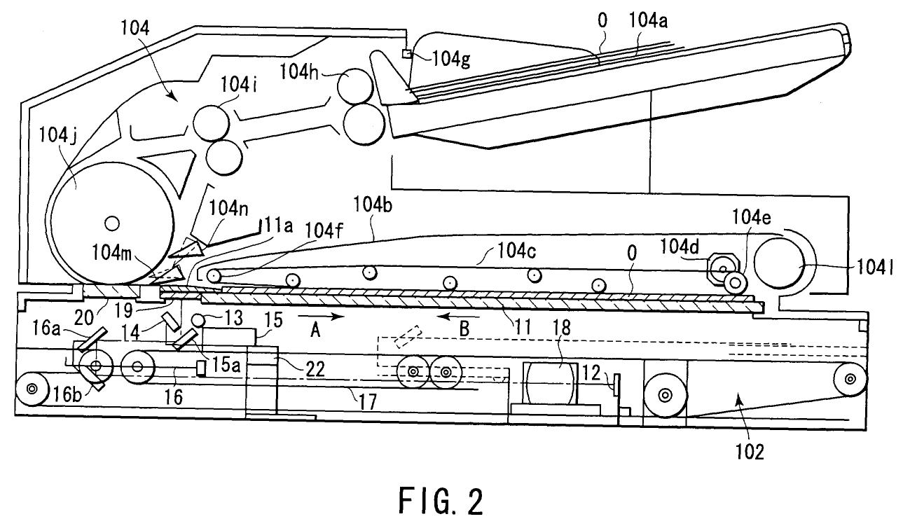

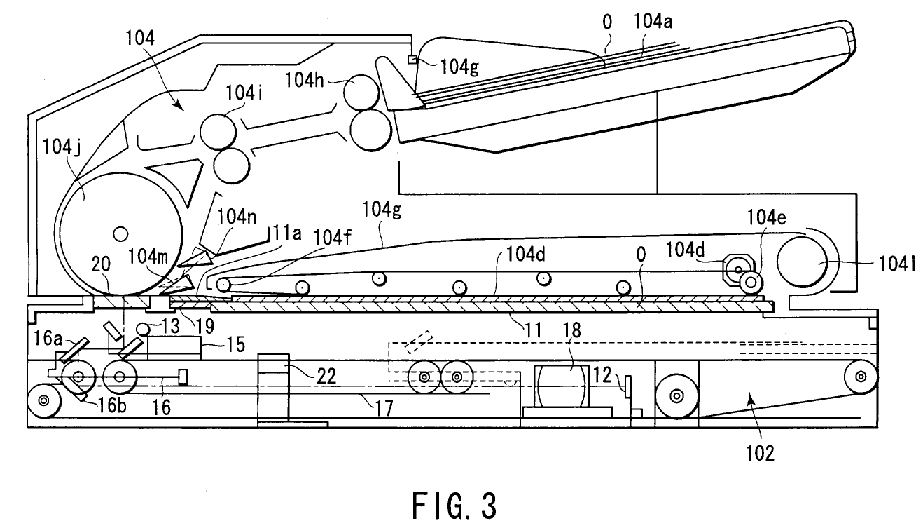

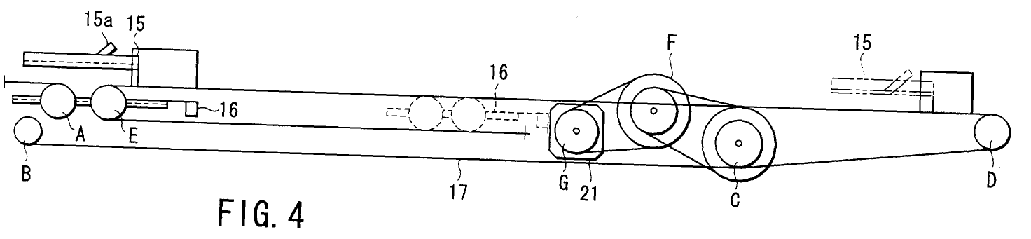

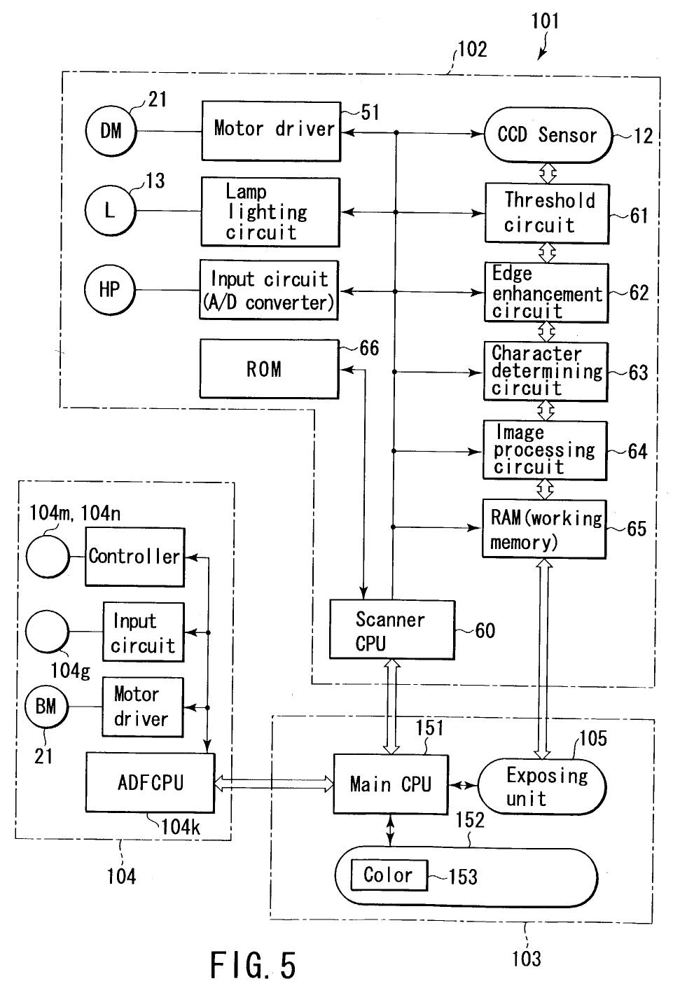

FIGS. 2 to 4 are schematic views for explaining an example of an image reader usable integrally with the image forming apparatus shown in FIG. 1. Nowadays, since an ADF is assembled integrally in an image reader in many cases, the details of the ADF will be explained as well. Moreover, FIG. 5 shows a control block of the digital copying machine (the image reader 102 and the image forming apparatus 103) and the ADF 104.

As shown in FIGS. 2 to 4, a transparent glass 11 made of a transparent plate-like flat member having a substantially constant thickness for supporting an object to be read (or to be copied), and a CCD sensor 12 for converting the image of the object to be copied O set on the transparent glass 11 to an electric signal, that is, image data, are provided at a predetermined position of the image reader 102. A size plate 11a for indicating the position of setting the object to be copied O on the transparent glass 11 is provided at one end of the transparent glass 11. Moreover, the object to be copied O is set, at a predetermined position on the transparent glass 11, in close contact with the transparent glass 11 by the ADF 104.

An illumination lamp 13 for illuminating the object to be copied O set on the transparent glass 11 and a reflector 14 for reflecting the light outputted by the illumination lamp 13 toward the object to be copied O on the transparent glass 11 below the transparent glass 11. A each of a length of the illumination lamp 13 and the reflector 14 is given capable of illuminating one side (depth direction) of the transparent glass 11.

The illumination lamp 13 and the reflector 14 are fixed on a first carriage 15 provided movably below the transparent glass 11. The first carriage 15 is movable at a predetermined speed in the direction of the other side (length direction) orthogonal to the one side (depth direction) of the transparent glass 11. Therefore, an image of the object to be copied O is taken out as the brightness and the darkness of the light concerning the narrow area in the depth direction (first direction) defined by the illumination light guided to the light receiving surface of the CCD sensor 12, by plurality of mirrors to be described later. Since the illumination lamp 13 and the reflector 14 on the first carriage 15 are moved in the length (second) direction, the entire image of the object to be copied O is taken out successively as the brightness and the darkness of light, and guided to the light receiving surface of the CCD sensor 12.

The first carriage 15 further includes a first image mirror 15a for guiding the image light of the object to be copied O as the reflected light reflected by the object to be copied O illuminated by the direct illumination light from the illumination lamp 13 and the reflection illumination light reflected by the reflector 14. The image light includes the image which is difference between an image area and a non-image area of the object to be copied O with respect to the brightness and the darkness of the light derived from the refractivity of the areas.

A second carriage 16 is provided in the direction for guiding the image light reflected by the first image mirror 15a of the first carriage 15, with a second image mirror 16a and a third image mirror 16b mounted for guiding the image light from the first image mirror 15a successively in a predetermined direction. The second and third image mirrors 16a, 16b are disposed so as to have a 90° reflection surface. Therefore, the reflected light from the object to be copied O guided by the first image mirror 15a of the first carriage 15 is reflected by the second and third image mirrors 16a, 16b of the second carriage 16 in the surface parallel to the transparent glass 11 surface direction.

The reflected light reflected by the third image mirror 16b is a band-like light limited by the total length of the illumination lamp 13 in the axis direction and the width defined at the time when the first image mirror 15a reflects the image light from the object to be copied O. Moreover, the first and second mirrors 16a, 16b are mounted on the second carriage 16 provided movably following the first carriage 15. The first carriage 15 and the second carriage 16 receive the thrust from a driving motor, described later, by a wire 17 with the both ends fixed at a predetermined position of the housing of the image reader 102 such that the second carriage 16 is moved at a ½ speed of that of the first carriage 15.

A lens 18 for providing a predetermined reduction ratio to the image light reflected by the third image mirror 16b is provided in the direction of guiding the image light reflected by the third image mirror 16b of the second carriage 16. The above-mentioned CCD sensor 12 is disposed at the focal position of the lens 18. The light receiving surface (no numeral given) of the CCD sensor 12 is mounted so as to be disposed at the focal position of the lens 18.

A white plate 19 for inputting the reference value of the white level at the time of the photo electric conversion of the image of the object to be copied O by the CCD sensor 12 is provided on the rear surface of the size plate 11a provided at the end part of the transparent glass 11, that is, on the surface on the first and second carriage 15, 16 side. The white plate 19 is not necessarily provided on the rear surface of the size plate 11a, and it may be disposed at the circumferential rim part of the housing of the image reader 102 with the first and second carriages 15, 16 withdrawn, that is, a predetermined position in the area outside the tip end part of the transparent glass 11 (tip end part of the object to be copied 0).

A reading window 20 for illuminating the sheet-like objects to be copied O being conveyed in the case where the object to be copied O is a sheet-like object to be fed using the ADF 104 is provided on the circumferential rim part side of the housing of the image reader 102 with respect to the end part of the transparent glass 11 at a predetermined position on the end part side of the housing with respect to the above-mentioned white plate 19.

The reading window 20 is a narrow plate made of the same material as that of the transparent glass 11, elongated in the depth direction (first direction). The reading window 20 directs the light from the illumination lamp 13 mounted on the first carriage 15 to the sheet-like objects to be copied O conveyed one by one by the ADF 104. Therefore, by using the reading window 20, the image information of the object to be copied O can be read out by the sheet-through method to the CCD sensor 12, without needing to move the first and second carriages 15, 16 along the transparent glass 11.

Although it is limited to the case of having the transparent glass 11 capable of placing a book and a three dimensional object other than the sheet-like object to be copied O, and the sheet-like object to be copied O, by providing the reading window 20, the time needed for the reciprocal movement of the two carriages 15, 16 can be shortened when the object to be copied 0 is a sheet-like object. In particular, since the time needed for returning the carriages 15, 16 to the original position can be shortened, the amount of reading (copying) per unit time can be increased.

Next, the details of the ADF 104 will be explained.

As shown in FIG. 2, a document tray 104a for holding one or a plurality of object to be copied O, and a document supporting part 104b for discharging the object to be copied O after reading out the image information either by the sheet-through method or the flatbed method, are provided.

A conveying belt 104c, for conveying the object to be copied O set in the document tray 104a to a predetermined position on the transparent glass 11, is provided opposite the transparent glass 11 of the image reader 102.

In the case where the object to be copied O is a three dimensional substance or a book, the conveying belt 104c can be moved away from the transparent glass 11, together with the ADF 104 main body by, for example, a hinge (not shown), or the like. The conveying belt 104c is disposed substantially parallel with the transparent glass 11 by a driving roller 104e to be rotated by the belt motor 104d for transmitting the rotation force of the motor 104d to the conveying belt 104c, and a tension roller 104f for applying a predetermined tension to the conveying belt 104c.

Between the document tray 104a and the conveying belt 104c, a document detecting sensor 104g for detecting whether or not the object to be copied O is set on the document tray 104a, a feed roller 104h for taking out the object to be copied O set on the document tray 104a one by one, and an intermediate roller 104i and a conveying roller 104j for conveying the object to be copied O taken out from the document tray 104a by the feed roller 104h toward the conveying belt 104c and the transparent glass 11 are provided successively from the document tray 104a side. The conveying roller 104j serves also as the inverting roller at the time of inverting the front and rear sides of the object to be copied O for reading out the image information on the both sides in the case where image information is provided on the both sides of the object to be copied O. Moreover, the document detecting sensor 104g serves also as a document determining sensor for determining whether the image information in the object to be copied O is a monochrome image or a color image.

Next, with reference to FIGS. 2 to 5, the image reading operation in the flatbed mode for reading the image with the object to be read set on the transparent glass of the image reader, and in the sheet-through mode for reading the image with the object to be read being conveyed to the reading window of the image reader will be explained.

The first carriage 15 in the image reader 102 is stopped with the width direction center of the first image mirror 15a disposed immediately below the white plate (white reference plate) in relation to detection of a predetermined position of the first carriage 15 by a home position sensor 22 (hereinafter referred to as the HP sensor 22).

The first carriage 15 is provided with a light blocking plate (not shown) for advising the position of the first carriage 15 in relation to the position of the first image mirror 15a.

Therefore, by stopping the driving motor 21 by a predetermined time after detection of passage of the light blocking plate by the HP sensor 22, the first carriage 15 can be stopped at a predetermined position. The light blocking plate (not shown) may be provided in the second carriage 16. Moreover, in place of the light blocking plate, a part of the structure of the first carriage 15 (or the second carriage 16) may be used.

When the image forming apparatus 101 is energized, the first carriage 15 is moved according to control of a scanner CPU 60 based on the initial program preliminarily stored in a ROM 66 so that the width direction center of the first image mirror 15a is disposed immediately below the white plate 19 with the HP sensor 22 position used as the reference. That is, when the image forming apparatus 101 is energized, the first carriage 15 is disposed at the home position.

Next, an example of the image information reading operation by the flatbed method will be explained.

When an arbitrary number of objects to be copied 0 are set on the document tray 104a of the ADF 104 and start of the reading operation or the copying operation of the image information is commanded from an operation panel 152, the illumination lamp 13 of the first carriage 15 is lit. That is, the white plate 19 is illuminated by the illumination lamp 13 and the reflector 14. Thereby, the reflected light is produced by the white plate 19 so that the reflected light is guided to the lens 18 via the first image mirror 15a, the second image mirror 16a and the third image mirror 16b. The reflected light from the white plate 19 guided by the lens 18 is provided with a predetermined converging property by the lens 18 so as to be focused on the light receiving surface of the CCD sensor 12. The reflected light from the white plate 19 focused on the CCD sensor 12 is photoelectrically converted by the CCD sensor 12 so as to be inputted to a threshold circuit 61 as a white plate reflected light amount signal. The white plate reflected light amount signal inputted to the threshold circuit 61 is processed at a predetermined level so as to be used for setting the correction amount for the shading correction.

In contrast, in the ADF 104, the feed roller 104h is rotated so as to take out a sheet of the object to be copied O set on the document tray 104a. Since a flapper 104m, explained later, is switched so as to define the conveyance path to the document supporting part 104b side such that the object to be copied 0 taken out from the document ray 104a is conveyed to the conveying belt 104c by the intermediate roller 104i and the conveying roller 104j, the object to be copied 0 conveyed by the conveying belt 104c is further conveyed by the conveying belt 104c on the transparent glass 11 of the image reader 102. The object to be copied 0 being conveyed on the transparent glass 11 is stopped at a predetermined position on the transparent glass 11 by stopping the belt motor 104d at a predetermined timing. The position for stopping the object to be copied O can be administered easily by detecting the rear end of the object to be copied O being conveyed by the intermediate roller 104i, the conveying roller 104j and the conveying belt 104c toward a predetermined position of the transparent glass 11 by for example a paper sensor (not shown), or the like provided in the vicinity of the conveying roller 104j, and stopping the belt motor 104d after passage of a predetermined time from detection of the rear end of the object to be copied O by the paper sensor.

When the object to be copied O is stopped at a predetermined position of the transparent glass 11 of the reader 102, the driving motor 21 is rotated according to control of the motor driver 51 of the reader 102 at a predetermined timing.

Hereafter, according to movement of the first and second carriages 15, 16 at a predetermined speed along the transparent glass 11 by the relative position change of the wire rope 17 by the rotation of the driving motor 21, the entirety of the object to be copied O on the transparent glass 11 is illuminated successively by the narrow band-like illuminating light in the depth direction from the illumination lamp 13 and the reflector 14.

The reflected light from the object to be copied 0 is reflected successively by the first image mirror 15a, the second image mirror 16a, and the third image mirror 16b so as to be focused successively on the light receiving surface of the CCD sensor 12 with a predetermined converging property provided by the lens 18.

The reflected light from the object to be copied 0 guided by the CCD sensor 12 is photoelectrically converted to a corresponding current value. The current value outputs from the CCD sensor 12 is thresholded by the threshold circuit 61 at a predetermined level, it is processed for voltage conversion. Furthermore, after being recognized as character information or image information through an edge enhancement circuit 62, a character determining circuit 63, an image processing circuit 64, or the like, it is stored in a working memory (RAM) 65 as the image data.

The image data stored in the RAM 65 is supplied to the exposing unit 105 in the case where the image forming (copying) by the image forming section 103 is commanded, and it is supplied to a storage destination or transfer destination (not shown) via a corresponding interface in the case where storage or transfer to a external device (not shown) is commanded.

If, the object to be read by flatbed mode using the flatbed method, including a color image by the operation panel 152 provided integrally to the image reader 103, even when the ADF 104 and the image reader 102 are waiting in the sheet-through mode for reading the image information of the object to be copied O by the below-mentioned sheet-through method at the time when the object to be copied O is set on the document tray 104a of the ADF 104.

Moreover, it is preferable that a color image key 153, or the like for advising the CPU 151 (image forming apparatus 103) and the ADF CPU 104k that the object to be copied O includes a color image is provided in the operation panel 152.

In contrast, the object to be copied O with the image information read out is discharged to the document supporting part 104b through the discharge roller 104i. Moreover, in the case where second and subsequent sheet-like subjects to be read O are set on the document tray 104a, the sheet-like subjects to be read are conveyed in the same manner.

Next, an example of the image information reading operation by the sheet-through method will be explained.

When an arbitrary number of objects to be copied 0 are set on the document tray 104a of the ADF 104 and start of the reading operation of the image information or the copying operation is commanded from the operation panel 152, the white plate 19 is illuminated and the threshold level is set as in the above-mentioned image information reading operation by the flatbed method.

Then, the driving motor 21 is rotated by a predetermined number of pulses in a predetermined direction so as to move the first carriage 15 such that the width direction substantial center of the first image mirror 15a of the carriage 15 faces the width direction substantial center of the reading window 20. As to the position (moving amount) for moving the first carriage 15, for example, since the first carriage 15 is disposed at the home position defined by stopping the driving motor 21 after passage of a predetermined time from detection of the light blocking plate by the Hp sensor 22 in the initial operation at the time of energizing the image reader 102, the width direction center of the first image mirror 15 substantially faces the sheet-through reading position with the conveying roller 104j and the reading window 20 facing with each other.

Hereafter, one of the objects to be copied O set on the document tray 104a is taken out by the feed roller 104h at a predetermined timing so as to be guided to the conveying roller 104j via the intermediate roller 104i.

The digital copying machine 101 according to the present invention (the image reader 102 and the image forming apparatus 103) is generally initialized in the sheet-through mode.

Therefore, since the conveyance path switching flapper 104m is switched so as to define the conveyance path to the document supporting part 104b side, the object to be copied O being conveyed by the conveying roller 104j is guided to the document supporting part 104b. In the case where the object to be copied O includes the image information on both the front and rear sides and the image information reading operation is commanded for the front and rear sides, the front and rear sides can-be inverted by switching the inverting flapper 104n for defining the conveyance path to the conveying roller 104j side.

According to the rotation of the conveying roller 104j, the object to be copied O being conveyed along the outer circumference of the conveying roller 104j is illuminated by the illumination light of the illumination lamp 13 and the reflector 104 of the reader 102 in the area facing the reading window 20.

The reflected light from the illuminated object to be copied O is guided to the lens 18 by the first image mirror 15a, the second image mirror 16a and the third image mirror 16b in the same manner as explained above for the flatbed mode. The reflected light of the object to be copied O guided by the lend 18 is focused on the CCD sensor 12 so as to be photo electrically converted and outputted as an image signal.

The image signal outputted from the CCD sensor 12 is processed at a predetermined level by the threshold circuit 61 in the same manner as explained above for the flatbed mode, electrically converted, and recognized as character information or image information through the edge enhancement circuit 62, the character determining circuit 63, the image processing circuit 64, etc., and stored in the working memory (RAM) 65 as image data.

The image data stored in the RAM 65 is supplied to the exposing unit 105 in the case where the image formation (copying) by the image forming section 103 is commanded, and it is supplied to a storage destination or transfer destination (not shown) via a corresponding interface in the case where storage or transfer to an external device (not shown) is commanded.

In contrast, since the conveyance path switching flapper 104m is switched so as to define the conveyance path on the object to be read supporting part 104b side, the object to be copied O passes by the reading window 20, and is discharged to the object to be read supporting part 104b side. In the case where the sheet-like object to be copied O has the image information on both sides and the image reading operation is commanded for both sides, the object to be copied O is guided to the conveyance roller 104c side so that the front and rear sides are converted and it is conveyed again to the reading window 20. Moreover, when second and subsequent sheet-like subjects to be read O exist, the sheet-like subjects to be read O are conveyed in the same manner.

According to the image reader 102 and the ADF 104 of the present invention, even when the initialized mode after energizing is the sheet-through mode, if the document detecting sensor 104g detects that the object to be copied O set on the document tray 104a includes a color image, the sheet-through mode is released so as to be set in the above-mentioned flatbed mode. The document detecting sensor 104g may either be the transmission type or the reflection type.

Moreover, without distinction of the sheet-through mode and the flatbed mode, in the same manner as in the sheet-through mode, the image information by a predetermined length of the tip end of the object to be copied O can be focused on the CCD sensor 12 at the position of the reading window 20 and the color component of the image signal outputted from the CCD sensor 12 can be recognized, by, for example the image processing circuit 64. In this case, by switching the conveyance path switching flapper 104m so as to guide the object to be copied O to the conveying belt 104c at the time when the object to be copied O is detected to include a color image, the flatbed mode can be defined. This method is particularly useful in the case where the document detecting sensor 104g has an inexpensive structure comprising a photo interrupter and a light blocking lever, incapable of distinguishing the image information.

As heretofore explained, according to the flatbed type image reader having a sheet-through mode of the present invention, the sheet-through mode and the flatbed mode can be selected or set depending on whether the object to be read supplied from the automatic document feeding unit includes a color image or only monochrome images. Therefore, in the case where the object needs to be read with high accuracy, as in a color photograph, etc., i.e. the object needs to be kept stationary, the flatbed mode can be switched to even if the sheet-through mode has been set.

Thereby, when the object to be read including only monochrome images is fed, high speed image information reading (and copying) can be enabled. In contrast, when the object to be read includes a color image, even though the time needed for reading the image information is increased, an image signal can be obtained with a high accuracy.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image reader comprising:
a CCD sensor which converts a reflected light produced by illuminating an object to be read to an image signal;
a transparent glass which supports the object to be read in a stationary state, and directs the illuminating light to the object to be read from the side opposite to the side on which the object to be read is disposed;
a sheet conveying unit which conveys the object to be read toward the transparent glass when the object to be read is sheet-like, and has an image determining mechanism which determines whether the image of the object to be read is a color image or a monochrome image;
a reading window which is disposed between the sheet conveying unit and the transparent glass, and directs the illuminating light to a part of the object to be read being conveyed by the sheet conveying unit from the side opposite to the side to which the object to be read is moved;
an illuminating unit which moves along the transparent glass and stops at a predetermined position facing the reading window, and directs the illuminating light to the stationary object to be read on the transparent glass, and the object to be read being moved with the illuminating light directed from the reading window;
a mirror set which includes one or more mirrors, is capable of moving along the transparent glass, and transmits at least one of the reflected light produced by illuminating the object to be read by the illuminating light, and the reflected light produced by illuminating the object to be read by the illuminating light through the reading window, to the CCD sensor;
a carriage member which moves along the transparent glass at a predetermined speed while supporting the mirror set and the illuminating unit, and directs the reflected light produced by illuminating the object to be read by the illuminating light through the reading window to a position at which a predetermined mirror in the mirror set can receive the reflected light; and
an image information reading setting mechanism which, if the image determining mechanism detects that the object to be read holds a color image, even when a first reading mode for obtaining the reflected light by directing the illuminating light to the object to be read through the reading window while moving the object to be read is set, sets a second reading mode for obtaining the reflected light by directing the illuminating light to the object to be read while moving the carriage along the transparent glass after stopping the object to be read at a predetermined position of the transparent glass.

2. The image reader according to claim 1, wherein the image determining mechanism includes an object-to-be-read detecting sensor which detects that the object to be read is set on the sheet conveying unit.

3. An image reader comprising:
a CCD sensor which converts a reflected light produced by illuminating an object to be read to an image signal;
a transparent glass which supports the object to be read in a stationary state, and is capable of directing the illuminating light to the object to be read from the side opposite to the side on which the object to be read is disposed;
a sheet conveying unit which is capable of conveying the object to be read toward the transparent glass when the object to be read is sheet-like;
a reading window which is disposed between the sheet conveying unit and the transparent glass, and is capable of directing the illuminating light to a predetermined area of the object to be read being conveyed by the sheet conveying unit from an opposite side direction to a direction to which the object to be read is moved;
an illuminating unit which moves along the transparent glass and is stopped at a predetermined position facing the reading window, and directs the illuminating light to the stationary object to be read on the transparent glass, and the object to be read being moved with the illuminating light directed from the reading window;
a mirror set which includes one or more mirrors, is capable of moving along the transparent glass, and transmits at least one of an image light produced by illuminating the object to be read by the illuminating light, and an image light produced by illuminating the object to be read by the illuminating light through the reading window, to the CCD sensor;
a carriage member which moves along the transparent glass at a predetermined speed while supporting the mirror set and the illuminating unit, and directs the image light produced by illuminating the object to be read by the illuminating light through the reading window to a position at which a predetermined mirror in the mirror set can receive the image light;
a type input mechanism which is capable of inputting whether the object to be read includes only a monochrome image or also a color image; and
an image information reading setting mechanism which, when the type input mechanism inputs that the object to be read includes only a monochrome image, focuses the image light to the CCD sensor with a first reading mode for obtaining the image light by directing the illuminating light to the object to be read through the reading window while moving the object to be read, and when the object to be read includes a color image, focuses the image light to the CCD sensor with a second reading mode for obtaining the image light by directing the illuminating light to the object to be read while moving the carriage along the transparent glass at a predetermined speed after stopping the object to be read at a predetermined position of the transparent glass.

4. The image reader according to claim 3, wherein the image information reading setting mechanism includes an input key capable of inputting the kind of the image of the object to be read.

5. An image reader comprising:
a CCD sensor which converts a reflected light produced by illuminating an object to be read to an image signal;
a transparent glass which supports the object to be read in a state kept still, and is capable of directing the illuminating light to the object to be read from the side opposite to the side on which the object to be read is disposed;
a sheet conveying unit which is capable of conveying the object to be read toward the transparent glass when the object to be read is sheet-like;
a reading window which is disposed between the sheet conveying unit and the transparent glass, and is capable of directing the illuminating light to a part of the object to be read being conveyed by the sheet conveying unit from the side opposite to the side to which the object to be read is moved;
an illuminating unit which is capable of moving along the transparent glass and being kept still at a predetermined position facing the reading window, and is capable of directing the illuminating light to the object to be read being kept still on the transparent glass, and the object to be read being moved with the illuminating light directed from the reading window;
a mirror set which includes one or more mirrors, is capable of moving along the transparent glass, and transmits at least one of an image light produced by illuminating the object to be read by the illuminating light, and an image light produced by illuminating the object to be read by the illuminating light through the reading window, to the CCD sensor;
a carriage member which is capable of moving along the transparent glass at a predetermined speed while supporting the mirror set and the illuminating unit, and is capable of moving the image light produced by illuminating the object to be read by the illuminating light through the reading window to a position at which a predetermined mirror in the mirror set can receive the image light;
a driving unit which allows any one of stopping the carriage member at a predetermined position, and moving the carriage along the transparent glass at a predetermined speed;
an image determining mechanism which is capable of recognizing whether or not the image of the object to be read is a color image; and
a sheet conveying unit control mechanism which, in the case where the image determining mechanism detects that the object to be read includes a color image, even when a sheet-through mode for obtaining the image light by directing the illuminating light to the object to be read through the reading window while moving the object to be read is set, sets a flatbed mode for obtaining the image light by directing the illuminating light to the object to be read while moving the carriage along the transparent glass after conveying the object to be read to a predetermined position of the transparent glass and keeping still the object to be read at the predetermined position of the transparent glass.

6. The image reader according to claim 5, wherein the image determining mechanism includes a detecting sensor which detects that the object to be read is set on the sheet conveying unit.

7. The image reader according to claim 5, wherein the image determining mechanism includes an image processing circuit capable of extracting a color component of the image signal outputted from the CCD sensor.

8. The image reader according to claim 7, wherein the flatbed mode for conveying the object to be read to the transparent glass is set according to control of the sheet conveying controlling unit when the sheet-through mode is used for inputting the image light to the CCD sensor and the color component is extracted from the image signal.

9. The image reader according to claim 8, wherein the driving unit is initialized in a state with the carriage kept still at a position for the sheet-through mode, and when the flatbed mode is set, the carriage is moved along the transparent glass at a predetermined speed.
